(19) United States
(12) Patent Application Publication
(10) Pub. No.: US 2005/0267296 A1
(43) Pub. Date: Dec. 1, 2005

(54) Cost-effective process for preparing agarose from gracilaria spp.

(75) Inventors: Arup Kumar Siddhanta, Gujarat (IN); Ramavatar Meena, Gujarat (IN); Kamalesh Prasad, Gujarat (IN); Bharatkumar Kalidas Ramavat, Gujarat (IN); Pushpito Kumar Ghosh, Gujarat (IN); Karuppanan Eswaran, Gujarat (IN); Sangaiya Thiruppathi, Gujarat (IN); Vaibhav Ajit Mantri, Gujarat (IN)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Council of Scientific & Industrial Research, New Delhi (IN)

(21) Appl. No.: 10/858,599

(22) Filed: Jun. 1, 2004

(51) Int. Cl. C08B 37/04

(52) U.S. Cl. 536/3

(57) ABSTRACT

The present invention relates to a simple, direct and cost-effective process for the preparation of agarose of high gel strength and low gelling temperature from naturally occurring or cultivated Gracilaria spp. more particularly Gracilaria dura, said process comprising steps of pre-treating the dry seaweed with alkali, rinsing the pre-treated seaweed until the washing shows a pH ranging between 7 and 8, adding water, autoclaving to obtain extractive, treating the extractive with charcoal and Celite to obtain hot extractive, vacuum-filtering the hot extractive over a Celite bed, freezing the filtrate into a mass and thawing the mass, redissolving the mass in water by heating in an autoclave, repeating the freeze-thaw cycle, straining the product to remove thawed liquid and thereafter squeezing to expel residual liquid to the extent possible to obtain agarose, and an agarose thereof.

### FIELD OF THE PRESENT INVENTION

A simple, direct and cost-effective process for the preparation of agarose of high gel strength and low gelling temperature from naturally occurring or cultivated Gracilaria spp. more particularly Gracilaria dura.

### BACKGROUND AND PRIOR ART REFERENCES OF THE PRESENT INVENTION

Reference may be made to the internet web site www.sporeworks.com which states that Agar primarily finds use in the food, medical/pharmaceutical and cosmetic industries. Agar is also used in other industries such as its recent application in the packaging foam industry for the production of biodegradable packaging foam. The site further describes the salient features of high quality bacteriological agar. It states that such agar should have a gelling temperature of 34°-35° Celsius to minimize possible degradation of heat sensitive antibiotics that are added into the culture medium after sterilization. It is further stated that the cooler agar is easier to handle and condensation in petri dish is less of a problem. Another important attribute of a good quality bacteriological agar is that it should possess a minimum gel strength of 800 gcm⁻² under standard conditions of measurement.

Reference may be made to the Fluka Catalog of 2003-2004 wherein the specifications are provided for a range of agar products.

Reference may be made to Sigma Catalog of 2000-2001 wherein it is stated that agarose is a purified linear galactan hydrocolloid isolated from agar or agar-bearing marine algae. A range of agarose in the gel strength range of 650-1200 g/cm² (1% solution) with gel point in the range of 36-42° C. are described. One drawback of such products is their high cost, which is presumably due to the elaborate purification processes involved.

Reference may also again be made to www.sporeworks.com which states that Gelidium seaweed produces the highest grade agar and agarose.

Reference may be made to the paper on production of bacteriological agar from Gelidium wherein it is reported that the products from this seaweed give high gel strength (R. Armisen, J. Appl. Phycology, 1995, 7:231-243, and J. Cosson et al. in Progress in Phycological Research, F. E. Round and D. J. Chapman, Eds., Biopress Ltd. 1995. Vol. 11; pp. 269-324).

Mention may be made of the paper by Andres Lemus et al. (Food Hydrocolloids, 1991, 5:469-479) wherein it has been reported that agar from different Gelidium species has gelling temperature from 34.0° to 37.5° C. and gel strength 687 to 1470 g/cm² obtained by a process which involves alkali pretreatment of the seaweed followed by adjustment of pH (with acid presumably) to 6 to 6.5 before extraction and purification of the extracted agar by two freeze-thaw cycles.

Mention may be made to “Process for producing agar-agar from an algae extraction juice” by Lebbar et al. (U.S. Pat. No. 4,780,534; 1988) wherein a process for making agar-agar from algae (Gelidium, Gracilaria and Pterocladia spp.) extraction juices and comprising: (a) placing the extraction juice in the presence of a cationic ion exchange resin conditioned into the Na⁺ form, then placing it (b) in the presence of an anion exchange resin conditioned into the Cl⁻ and/or SO₄²⁻ form, then (c) optionally placing the juice in the presence of a cation ion exchange resin conditioned into the OH⁻ form, (d) thereupon gelling the juice, (e) extracting the agar-agar from the obtained gel, and where called for (f) treating the obtained powder by placing it in contact with an ozone-loaded carrier gas. Such a process allows producing at reduced costs high-grade agar-agar, useful in particular in the medical, pharmaceutical and bioengineering fields. The gel strength was reported in the range 820-910 g/cm² in 1.5% gel.

Mention may be made of the paper by M. Y. Roleda et al. (Botanica Marina 1997, 40:63-69) where agars from Gelidiella acerosa having gelling temperatures of 38° C. and 47° C., and gel strengths of 493 and 200 g cm⁻², respectively, have been reported to be prepared by a process involving acetic acid pretreatment before extraction.

Mention may be made to the article of O. P. Mairh et al. (Botanica Marina 1978, 21:169-174) wherein it is reported that agar from cultured Gelidium pusillum obtained from the Arabian Sea at west coast of India has gel strength of 210 g cm⁻² which is considered as poor in the context of the present invention. Moreover, no information is provided on gelling temperature.

Reference may be made to Krishnamurthy et al. (Proceedings, symposium on marine algae of Indian Ocean Region, Central Salt & Marine Chemicals Research Institute, Bhavnagar, 1979, p 41) wherein it is stated that the maximum gel strength of 325 g cm⁻² was obtained from Gelidiella acerosa whereas the corresponding gelling temperature was 38-52° C.

Reference may also be made to K. S. Pillai (J. Phycol., 13 (Suppl.), 1977, p 54) who has attempted optimization of process conditions to maximize quality of agar and reported a yield from Gelidiella acerosa as high as 48% but with maximum gel strength of 300 g/cm² whereas the corresponding numbers were 45-50% and 125 g/cm² for Gracilaria (species not mentioned).

Reference may be made to Patel et al. (J. Phycol. 13 (Suppl.), 1977, p 52) who obtained a yield of 24.3% and gel strength of 790 g/cm² from Gelidiella acerosa growing in the Indian coast.

It can be seen that the best reported result for Gelidium is a gel point of 37.5° C. and gel strength of 1470 g/cm² for 1.5% gel whereas the best reported gel strength is 790 g/cm² in case of Gelidiella species. If products such as agarose with still superior specifications are required, then the agar needs to be further purified for this purpose. It would be desirable if such products can be made from seaweed sources without elaborate purification.

Mention may be made to “Purification of agar” by Kiyoshi Arai et al. (JP 7017,130, Jan. 13, 1970; Chemical Abstr. 74, 32889r, 1971) wherein it is reported that crude agar was extracted with DMF to separated high purity agarose. 10 g Agar mixed with 500 ml DMF with stirring, dipped 10 h in hot water, centrifuged, the supernatant poured into 2 liter acetone, and the precipitates are passed through a glass filter, washed with 500 ml acetone, dissolved in hot water and filtered to give agarose powder.

Mention may be made to “Isolation of partially purified agarose with a quaternary base” by Craigie and Leigh (in Handbook of Phycological Methods, edited by J A Hellebust and J S Craigie, Cambridge University Press, Cambridge, 1978; p. 126) where 250 mg of crude agar was dissolved in 100 ml of boiling distilled water. 25 mg of λ-carrageenan was added and 10 ml 2% Cetavlon (cetylpyridinium chloride) was added at 80-100° C. solution. The hot extractive was filtered with Celite and pressure filtered over membrane (0.8 micron) followed by freezing and thawing of the product to have partially purified agarose.

Mention may be made to “Agarose purification method using glycol” by R. B. Provonchee (U.S. Pat. No. 4,990,611, February 1991) where purified agarose was recovered from agar or impure agarose by dissolving the agar or agarose in a lower alkylene glycol at elevated temperature, cooling the agar or agarose-containing glycol solution to induce precipitation of a purified agarose product, and recovering the precipitated agarose product.

Mention may also be made to U.S. Pat. No. 4,983,268 by Kirkpatrick et al. that describes the preparation purified agarose suitable for rapid electrophoresis, characterized by a sulfate content less than 0.2 wt % and gel strength of at least 1200 g/cm² (1%). Agaroses are purified by dissolving agarose or alkali-modified agar in an aqueous medium buffered at a pH of 6.0 to 8.0 and containing no more than 2.0 nM salt as chloride, and precipitating the agarose by contact with lower alkanol.

Reference may also be made to the work of Alfred Polson (Chemical Abstract 65: p 5865a; 1965) wherein fractionation of mixture of agarose and agaropectin has been described for preparation of agarose. The mixture is treated with an aqueous solution of poly(ethylene glycol) of molecular weight 300, giving a precipitate enriched in agarose. In this process 80 g of lonagar No. 2 was dissolved in 2 liter of water. To the hot solution (80° C.) was added 2 liters of 40% (wt/vol) polyethylene glycol of molecular weight 6000 and the resultant precipitate separated by filtration through 110 mesh nylon cloth. The precipitate then washed at 40° C. for 2-3 minutes, suspended in water at 15° C., stirred overnight in 5 liters of water, collected in nylon mesh, washed with acetone and dried in warm air.

Reference may be made to the publication of R. Armisen (J. Appl. Phycol. 1995, 7:231-243) wherein it has been stated that world's first source of agar, from the middle of the seventeenth century, was Gelidium from Japan, but by the beginning of the twentieth century demand for the phycocolloid exceeded supply of this algae which made it necessary to look at alternative seaweed sources. It has also been stated that the development of production process through alkaline hydrolysis of sulphates has allowed good quality food grade agar to be obtained from Gracilaria.

Reference may be made to the paper of A. Q. Hurtado-Ponce et al. (Botanica Marina 1988, 31:171-174) which has reported agars having poor gel characteristics, specifically different gelling temperature and gel strengths (low and high and vice versa) from various Gracilaria species, as follows: (i) agar from a Gracilaria sp. (no species details provided) having gelling temperature 41.3° C. and gel strength of 470 g/cm²; (ii) agar from Gracilaria edulis having gelling temperature of 55° C. and gel strength of 140 g/cm²; (iii) agar from Gracilaria verrucosa having gelling temperature of 53° C. and gel strength of 270 g/cm²; (iv) agar from Gracilaria eucheumoides having gelling temperature of 34° C. and gel strength of 130 g/cm².

Reference may be made to the paper of J. Rebello et al. (J. Appl. Phycol. 1997, 8:517-521) where agar of Gracilaria gracilis having high gelling temperature (59° C.) with low gel strength (350 g/cm²) has been reported.

Mention may be made to the internet website (www.rheofuture.com) and the paper by Y. Freile-Pelegrin et al. (J. Appl. Phycol. 1997, 9:533-539) wherein it is reported that, in the pretreatment of Gracilaria for agar extraction, the optimum concentration of alkali is species specific. The authors of the latter paper further mention that the alkali was neutralized by soaking the pre-treated seaweed in 0.025% H₃PO₄ for light alkali pretreatment and in 0.025% H₂SO₄ for 3% and 5% NaOH pretreatment. Such pretreatment was found to give gel strength of agar in the range of 974-1758 g/cm² from Gracilaria cornea of Yucatan, Mexico. However, with increase of gel strength the gelling temperature also increases and the agar having gel strength of 1758 g/cm² has gelling temperature of 42-43° C. whereas for many applications there is a requirement of low gelling temperature and high gel strength.

Reference may be made to the paper by R. D. Villanueva et al. (Botanica Marina Vol. 40, 1997, pp 369-372), which reports the optimized agar extraction from Gracilaria eucheumoides Harvey. In this method the seaweed is subjected to pretreatment with NaOH and then washed with 0.5% acetic acid. With optimized process conditions, the maximum gel strength obtained was 423±43 g/cm². No mention is made of the corresponding gelling temperature.

Ma. R. J. Luhan has also carried out a study similar to that described above (Botanica Marina, 35, 1992, pp. 169-172) for Gracilaria heteroclada collected from Iloilo, Central Philippines and the gel strength was found to be in the range of 510-794 g/cm² for seaweed collected during the early dry season and 43-101 g/cm² for material collected during the wet season. No mention is made of gelling temperature.

E. Marinho-Soriano reported extraction of agar polysaccharides from different Gracilaria species (Rhodophyta, Gracilariaceae) including Gracilaria dura (Journal of Biotechnology 89:81-84, 2001), using hot water extraction at 110° C. for 1 hr, without any pretreatment of the seaweed. The gel strength of agar was reported to be 318±49 g/cm².

Reference may be made to E. Murano et al. (Hydrobiologia 204/205:567-571, 1990) who have referred to the occurrence of Gracilaria dura in the Adriatic Sea.

Reference may be made to E. Murano et al. (Carbohydrate Polymers 1992, 18:171-178) where it was reported that agar was extracted from Gracilaria dura growing in northern Adriatic Sea, both with and without alkali pretreatment. Alkali pretreatment was followed by neutralization with HCl before extraction. Gel strength of native and alkali treated agar were reported to be 160 and 390 g/cm².

Reference may be made to E. Murano, C. Brandolin, F. Zanetti, S. Paoletti and R. Rizzo (Hydrobiologia 204/205:567-571, 1990) who reported characterization of an agar fraction extracted from Gracilaria dura (Gracilariales, Rhodophyta) occurring in northern Adriatic Sea as tentatively cultivated in integrated polyculture systems, using hot water (90° C.) and 0.5M NaOH (90° C., 3 hr) followed by enzymatic treatment by means of amylase. Besides the fact that the reported results offer nothing unusual in terms of the quality of agar, this is a more complex method of processing than the conventional method of agar extraction.

Reference may also be made to E. Marinho-Soriano (Journal of Biotechnology 89:81-84, 2001) who has reported the occurrence of Gracilaria dura in Thau lagoon (43°24′N; 03°32′E) in the Mediterranean Sea.

Reference may be made to R. M. Oza and S. H. Zaidi (A revised checklist of Indian marine algae, National Marine Data Centre on Algae and Marine Chemicals, Department of Ocean Development, Government of India; Central Salt and Marine Chemicals Research Institute, Bhavnagar, Gujarat, India, 2001; p 25) who have reported the natural occurrence of Gracilaria dura (C. Agardh) J. Agardh (Rhodophyta, Gracilariaceae) in the west coast of India

Reference may be made to A. K. Siddhanta, et al. (Seaweed Research and Utilisation 19 (1&2): 95-99, 1997) who reported the preparation of agar from the natural stock of Gracilaria dura collected from the west coast of India. The dry seaweed was pretreated with 1 N sulfuric acid followed by neutralization with 1.5% alkali. Agar having gel strength of 260 g/cm² was obtained through this process. It will be evident from the above examples that there are no reports of preparation of agar from any Gracilaria species having simultaneously a high gel strength (>1500 g/cm² at 1% level) and low gelling temperature (35-36° C.).

It will further be seen from the above examples that in all instances Gracilaria seaweeds have been either extracted directly with water or subjected to pretreatment to effect alkaline hydrolysis and the excess alkali subsequently neutralized with acids (HCl, H₂SO₄, CH₃COOH and o-phosphoric acid) prior to extraction of agar.

Reference may be made to the article by H. H. Selby and R. L. Whistler (Industrial gums—Polysaccharides and their Derivatives, R. L. Whistler and J. N. BeMiller, Eds., 3rd Edition, Academic Press Inc., New York, 1993, pp 87-103). It is mentioned therein that several types of seaweeds may be blended to provide an agar composition of desired characteristics. No mention has been made, however, of any formulations based on Gracilaria dura.

It will be evident from the prior art that the quality of agar claimed to be produced from Gracilaria dura growing in different regions of the world is rather ordinary and there are no reports of agarose type products having high gel strength and low gelling temperature that have been produced from this seaweed.

### OBJECTS OF THE PRESENT INVENTION

The main object of the invention is to prepare agarose from Gracilaria dura occurring in Indian waters.

Another object is to prepare agarose having very high gel strength (>1900 g/cm²; 1% gel at 20° C.), low gelling temperature (˜35° C.), low (≦0.25) sulfate residue and low ash content (<1%) in a cost-effective manner.

Yet another object is to prepare agarose by pretreating the seaweed with an optimum concentration of alkali.

Yet another object of the invention is to remove residual alkali (after pretreatment) through water rinses only instead of by the conventional method of neutralization with acid.

Yet another object is to demonstrate that the above method of excess alkali removal yields a product with greatly enhanced gel strength.

Yet another object is to prepare spray dried agarose for easier dissolution of the product.

Yet another object is to demonstrate that there is no significant deterioration in agarose quality when the dry Gracilaria dura seaweed is stored in plastic bags under ambient condition for well over a year.

Yet another object of this invention is to demonstrate that the seaweed is amenable to cultivation, even at locations distant from its natural origin.

Yet another object of this invention is to demonstrate that the quality of agarose obtained from naturally occurring- and cultivated Gracilaria dura are similar.

Another object of the invention is to demonstrate that production of agarose from Gracilaria dura in sufficient quantity is feasible even though its natural occurrence is limited.

### SUMMARY OF THE PRESENT INVENTION

The present invention relates to a simple, direct and cost-effective process for the preparation of agarose of high gel strength and low gelling temperature from naturally occurring or cultivated Gracilaria spp. more particularly Gracilaria dura, said process comprising steps of pre-treating the dry seaweed with alkali, rinsing the pre-treated seaweed until the washing shows a pH ranging between 7 and 8, adding water, autoclaving to obtain extractive, treating the extractive with charcoal and Celite to obtain hot extractive, vacuum-filtering the hot extractive over a Celite bed, freezing the filtrate into a mass and thawing the mass, redissolving the mass in water by heating in an autoclave, repeating the freeze-thaw cycle, straining the product to remove thawed liquid and thereafter squeezing to expel residual liquid to the extent possible to obtain agarose, and a agarose thereof.

### DETAILED DESCRIPTION OF THE PRESENT INVENTION

Accordingly, the present invention relates to a simple, direct and cost-effective process for the preparation of agarose of high gel strength and low gelling temperature from naturally occurring or cultivated Gracilaria spp. more particularly Gracilaria dura, said process comprising steps of pre-treating the dry seaweed with alkali, rinsing the pre-treated seaweed until the washing shows a pH ranging between 7 and 8, adding water, autoclaving to obtain extractive, treating the extractive with charcoal and Celite to obtain hot extractive, vacuum-filtering the hot extractive over a Celite bed, freezing the filtrate into a mass and thawing the mass, redissolving the mass in water by heating in an autoclave, repeating the freeze-thaw cycle, straining the product to remove thawed liquid and thereafter squeezing to expel residual liquid to the extent possible to obtain agarose.

In an embodiment of the present invention, wherein the invention relates to an agarose of following characteristics:
i. about 1% (≧1900 g/cm²) gel strength at about 20° C.,
ii. 35 to 35.5° C. gelling temperature,
iii. ≦0.25% sulphate content, and
iv. ≦0.9% ash content,

In yet another embodiment of the present invention, wherein the agarose is obtained from Gracilaria spp. more particularly Gracilaria dura.

In still another embodiment of the present invention, wherein the agarose gel has melting temperature ranging between 98-100° C.

In still another embodiment of the present invention, A simple, direct and cost-effective process for the preparation of agarose of high gel strength and low gelling temperature from naturally occurring or cultivated Gracilaria spp. more particularly Gracilaria dura, said process comprising steps of:
obtaining dry seaweed Gracilaria spp,
pre-treating the dry seaweed with about 35 parts (v/w) of about 1 to 15% alkali at 25 to 95° C. for 0.5 to 5.0 hours,
rinsing the pre-treated seaweed thoroughly with water to remove excess alkali until the washing shows a pH ranging between 7 and 8,
adding about 35 parts (v/w) of water for about every one part of original seaweed and autoclaving at about 115-125° C. for time duration ranging between 1.5 to 2.0 hours to obtain extractive,
treating the extractive with about 0.05 to 0.07% charcoal and about 10-15% Celite at a temperature ranging between 85 and 95° C. to obtain hot extractive,
vacuum-filtering the hot extractive over a Celite bed,
freezing the filtrate into a mass at about −20° C. for 12 to 15 hours and thawing the mass,
redissolving the mass in about 25 parts of water by heating in an autoclave,
repeating the freeze-thaw cycle if required,
straining the product of step (i) to remove thawed liquid and thereafter squeezing to expel residual liquid to the extent possible to obtain agarose, and
optionally redissolving the solid and spray drying to obtain fine powder.

In still another embodiment of the present invention, wherein the alkali is sodium hydroxide.

In still another embodiment of the present invention, wherein the concentration of alkali is about 10%.

In still another embodiment of the present invention, wherein the time duration of autoclaving at step (d) is preferentially about 1.5 hours.

In still another embodiment of the present invention, wherein the agarose yield is ranging between 20-23% of dry seaweed weight.

In still another embodiment of the present invention, wherein pre-treating the seaweed at temperature preferably about 85° C.

In still another embodiment of the present invention, wherein pre-treating the seaweed for preferentially about 2.0 hours.

In still another embodiment of the present invention, wherein the autoclaving is at temperature preferentially about 120° C.

In still another embodiment of the present invention, wherein concentration of charcoal is about 0.06%.

In still another embodiment of the present invention, wherein concentration of Celite is about 12.5%.

While the prior art reveals that high quality agar and agarose are mainly obtained from Gelidium and Gelidiella seaweeds, and that agar extracted from Gracilaria dura exhibits gel strength only in the range of 160-390 g/cm² (1.5%), the present invention describes the preparation of agarose from Gracilaria dura occurring sparsely in the Arabian Sea in the west coast of India and the same seaweed cultivated successfully to increase biomass for practical utility, wherein the fresh seaweed was harvested, dried in the field, re-soaked in the laboratory at ambient temperature, treated with aqueous NaOH, washed with water to remove excess alkali, soaked in excess water, pressure-cooked, then the hot extractive was homogenized, then boiled in presence of clarifying aids, filtered over a Celite bed, the filtrate was subjected to freeze-thaw cycle, the solid obtained was re-dissolved and once again subjected to freeze-thaw to further reduce impurities, air dried and ground or preferably redissolved in water and spray dried.

In an embodiment of the present invention, Gracilaria dura was harvested from Veraval coast in western India situated at 20°54′N, 70°22′E.

In another embodiment of the present invention, alkali pretreatment was carried out for 1-2 h at 80-85° C. using sodium hydroxide as the alkali of choice.

In another embodiment of the present invention, the concentration of alkali for pretreatment was in the range of 0-15% (w/v) and preferably 10%.

In another embodiment of the present invention, the volume of alkali taken was 300 mL for every 10 g of seaweed.

In yet another embodiment of the present invention excess alkali after pretreatment was removed by rinsing the seaweed with water thereby avoiding the use of any acid and the pH was ensured to be in the range of 7-8 in the final washing.

In yet another embodiment of the present invention, the wet seaweed after pretreatment was taken in water in an autoclave wherein the water quantity was 300 mL for every 10 g of dry seaweed taken initially.

In yet another embodiment of the present invention, the pretreated seaweed was cooked in water for 1.5-2.0 h at 120° C.

In yet another embodiment of the present invention, the hot extractive was discharged at 70-80 ° C., following which charcoal and celite were added into the extractive and then taken to boiling at atmospheric pressure.

In yet another embodiment of the present invention, the boiling extractive was vacuum filtered over a celite bed.

In yet another embodiment of the present invention the clear hot filtrate was poured into flat steel trays and allowed to cool to room temperature so as to form a gel.

In yet another embodiment of the present invention the gel was sliced at regular intervals along the x and y axes with a knife and then cooled to −20° C. over 2-5 h to freeze the mass and then maintained at the low temperature for 12-15 h.

In yet another embodiment of the present invention, the process of freeze-thaw was repeated if required.

In yet another embodiment of the present invention, the agarose obtained under optimum extraction conditions had gel strength of >1900 gcm⁻² at 1% concentration and 20° C. temperature.

In yet another embodiment of the present invention, gel prepared from the agarose obtained under optimum extraction conditions had a melting temperature of 98-100° C. whereas the sol had a gelling temperature of 35.0-35.5° C.

In yet another embodiment of the present invention, the agarose obtained under optimum processing conditions had a sulphate content of ≦0.25% and ash content of ≦0.9%

In yet another embodiment of the present invention, the hot agarose sol was spray dried for easy dissolution on heating.

In yet another embodiment of the present invention, Gracilaria dura was amenable to cultivation in polythene bag or raft in the Gulf of Mannar at the southeast coast of India with up to 5% daily growth rate for cultivation on raft in krusadai island (9°16′N, 79°19′E).

In yet another embodiment of the present invention, naturally occurring and cultivated seaweeds yielded agarose of similar quality making the invention practically feasible in view of the large biomass that can be generated through cultivation.

In yet another embodiment of the present invention, the quality of agarose extracted from dry seaweed stored in plastic bags for up to 1 year was similar to that of agarose prepared from freshly dried seaweed.

Accordingly, the present invention describes the preparation of agarose of high gel strength and low gelling temperature from naturally occurring or cultivated Gracilaria dura by a process involving: (i) weighing of the dry seaweed, (ii) pretreatment of the dry seaweed with 35 parts (v/w) of 10% sodium hydroxide at 85° C. for 2 h, (iii) rinsing the seaweed thoroughly with water to remove excess alkali until the washing shows a pH of 7-8, (iv) adding 35 parts (v/w) of water for every one part of original seaweed and autoclaving at 120° C. for 1.5 h, (v) treating the extractive with 0.06% charcoal and 12.5% Celite (percentages w.r.t. weight of dry seaweed taken) at a temperature of 85-90° C., (vi) vacuum filtering the hot extractive over a Celite bed, (vii) freezing the filtrate at −20° C. for 15 h and then thawing the mass, (viii) redissolving the mass in 25 parts of water by heating in an autoclave, (ix) repeating the freeze-thaw cycle if required, (x) straining to remove thawed liquid and thereafter squeezing to expel residual liquid to the extent possible, (xi) redissolving the solid and spray drying to obtain fine powder.

Gel strength was measured on a Nikkansui type gel tester in 1.5% agar gel at 20° C. TGA was measured on a STAR-Toledo TGA machine, Switzerland. Molecular weight determination was done measuring intrinsic viscosity on an Ostwald Viscometer (cf. C. Rochas and M. Lahaye. Carbohydrate Polymers 1989, 10:289). Gelling and melting temperatures were measured following the method described by Craigie et al. (Hand Book Of Phycological Methods, 1978 (Eds. Hellebust. J A and Craigie J S, Cambridge University Press); pp.127), ash content was measured by incinerating the solid at 800° C. for 6 h, sulphate content was estimated by treating the ash with concentrated nitric acid, evaporating to dryness, dissolving the residue in water, filtering, and subjecting to ICP-OES analysis for S.

The main inventive step is moving away from the traditional belief that Gelidium and Gelidiella are the only seaweeds occurring in the Indian coast that yield high quality agar.

Another inventive step is revisiting of the seaweed, Gracilaria dura, given up originally as of little utility both because of the ordinary quality of agar obtained and limited biomass in nature.

Another inventive step is identification of optimum NaOH strength for pretreatment of the seaweed.

Another inventive step is avoiding the conventional process of neutralizing excess alkali (after pretreatment) with acid and instead giving water rinses only for removal of such excess alkali and thereby preventing acid-catalysed degradation of the polysaccharide which can occur due to high local concentrations of acid.

Another inventive step is being undeterred by the low biomass of the seaweed in nature and taking recourse to cultivation in suitable locations.

Another inventive step is identifying raft cultivation as a viable cultivation method that can yield daily growth rate in excess of 5% in suitable coastal locations.

Another inventive step is revisiting a seaweed that had was given up originally as of little utility.

Another inventive step is being undeterred by the low biomass of the seaweed in nature and taking recourse to cultivation in a conducive environment at a very different location from the location of natural origin.

Another inventive step is cultivating the seaweed by vegetative cutting on a raft placed in the open, placid sea and thereby obtaining high daily growth rate.

Another inventive step is the recognition from the prior art that different seaweed substrates may require different amounts of alkali in the pretreatment step and subsequent optimization of alkali concentration.

Another inventive step is the recognition that the process of removal of alkali followed in the prior art, namely neutralization of excess alkali with acid, may pose difficulties in view of the instantaneous build up of high local concentration of acid in the system that would be detrimental to the stability of the linear galactan molecule.

Another inventive step is to make a spray dried product for easy dissolution upon heating.

Another inventive step is the systematic study leading to the finding that the seaweed after sun drying has adequate shelf life for prolonged storage that is necessary as cultivation may not be yearlong activity.

Another inventive step is the preparation through a solvent-free process.

The following examples are given by way of illustration and, therefore, should not be construed to limit the scope of the present invention. Examples 1 and 2 pertain to the prior art whereas Examples 3-8 illustrate the invention described herein.

### EXAMPLE 1

Gracilaria dura from Veraval, India (20°54′ N and 70°22′ E) was harvested in April 2003 and sun-dried. 15 g of the seaweed was soaked in tap water for 1 h at ambient temperature (30-35° C.) and the water then discarded. The wet seaweed was then taken in distilled water (seaweed:water =1:35, w/v) and autoclaved at 120° C. for 1.5 h. The extract was homogenized and boiled with clarifying agents (charcoal and Celite) followed by filtration over a Celite bed under reduced pressure. The filtrate was then frozen at −20° C. for 15 h and then thawed. The contents were then taken in a cloth and the water squeezed out to the maximum extent possible. The residue was then air dried at ambient temperature (30-35° C.) and subsequently oven dried at 50° C. for 2 h. 4.41 g of agar (32.5% yield based on bone-dry seaweed) was obtained having 265 g/cm² gel strength (1.5% gel; 20° C.), 32° C. gelling temperature, 8.04% ash and 3.26% sulphate.

### EXAMPLE 2

Gracilaria dura of Example 1 was initially soaked in water, the water then discarded and the wet seaweed treated with 5% NaOH at 80-85° C. for 2 h followed by washing the seaweed with water to remove excess alkali. Residual alkali was neutralized with 0.5% acetic acid in one case and with 0.025% H₂SO₄ in another case. The seaweed was then subjected to autoclaving and further worked up as described in Example 1. The results obtained are summarized in Table 1.

TABLE 1
Agar obtained with alkali treatment and neutralization
of residual alkali with acid

| | | Yield (g); | Gel strength | |
|---|---|---|---|---|
| | | (% yield w.r. | (g/cm²) at | Gel- |
| Seaweed | Pretreatment | to bone dry | 20° C.; | ling T |
| quantity | conditions | seaweed) | (% gel) | (° C.) |
| 20 g | 5.0% alkali, acid wash | 3.6 (21.0) | 470 | 33.5 |
| | with 0.025% H₂SO₄ | | (1.0%) | |
| 10 g | 5.0% alkali, acid wash | 1.31 (15.0) | 465 | 33.0 |
| | with 0.5% AcOH | | (1.0%) | |

### EXAMPLE 3

20 g of dry Gracilaria dura was processed as in Example 2, except that the seaweed after alkali treatment was only subjected to water rinses to remove all the alkali and no acid was used in the process. As can be seen from Table 2 below, a significant enhancement of gel strength was observed as a result of the modification.

TABLE 2
Agar obtained after removal of residual alkali from the seaweed by water wash

| | | Yield (g); (% yield | Gel strength | | | |
|---|---|---|---|---|---|---|
| Seaweed | Pretreatment | w.r. to bone | (g/cm²) | Gelling T | Ash | Sulphate |
| quantity | conditions | dry seaweed) | at 20° C.; (% gel) | (° C.) | (%) | (%) |
| 20 g | 5% alkali, | 3.8 | 1620 (1.0%) | 35.0 | 2.02 | 0.50 |
| | water wash | (21.0%) | | | | |

### EXAMPLE 4

Gracilaria dura was treated with different concentrations of alkali, otherwise following the process of Example 3 in all the cases. The results of the study are shown in Table 3. It can be seen from the table that 10% alkali is the optimum concentration that yields maximum gel strength while at the same time avoiding alkali concentrations beyond that which is required.

TABLE 3
Properties of agar/agarose for different alkali pretreatment

| Seaweed | Pretreatment | Yield (g); (% yield | Gel strength (g/cm²) | | Gelling T | Ash | Sulphate |
|---|---|---|---|---|---|---|---|
| quantity | conditions | w.r. to bone dry seaweed) | at 20° C.; (% gel) | | (° C.) | (%) | (%) |
| 15 g | 1.5% alkali, | 3.10 (20.7) | 275 | (1.0%) | 33.0 | 4.5 | >0.5 |
| | water wash | | | | | | |
| 10 g | 3% alkali, | 1.98 (22.0) | 800 | (1.0%) | 35.0 | 3.4 | >0.5 |
| | water wash | | | | | | |
| 20 g | 5% alkali, | 3.80 (21.0) | 1620 | 1.0%) | 35.0 | 2.02 | 0.50 |
| | water wash | | | | | | |
| 10 g | 7% alkali, | 1.80 (20.0) | 1875 | 1.0%) | 35.0 | 1.80 | <0.50 |
| | water wash | | | | | | |
| 10 g | 10% alkali, | 1.85 (20.5) | >1920 | 1.0%); | 35.0 | ≦0.9 | ≦0.25 |
| | water wash | | 1450 | (0.75%); | | | |
| | | | 900 | (0.5%) | | | |
| 15 g | 15% alkali, | 3.20 (23.0) | >1920 | 1.0%); | 35.0 | ≦0.9 | ≦0.28 |
| | water wash | | 1465 | (0.75%); | | | |
| | | | 900 | (0.5%) | | | |

### EXAMPLE 5

The product of EXAMPLE 4 was compared with the product obtained wherein Gracilaria dura was treated with 10% alkali as in Example 4 but wherein residual alkali was neutralized with 0.5% AcOH as was done in one of the cases of Example 2. It can be seen from Table 4 that the reduction in gel strength accompanying neutralization with AcOH leads to a concomitant decrease in the molecular weight of the linear galactan. This suggests strongly that acidic catalyzed hydrolytic degradation of the polysaccharide is responsible for lowering of gel strength.

TABLE 4
Agar extracted under various concentrations of alkali
pretreatment conditions followed by acid wash

| | | Yield (g); | Gel strength | | Weight averaged |
|---|---|---|---|---|---|
| Seaweed | Pretreatment | (% yield w.r. to | (g/cm²) at | | molecular weight |
| quantity | conditions | bone dry seaweed) | 20° C.; (% gel) | | (Daltons) |
| 10 g | 10% alkali, acid wash | 1.63 (18.1) | 1025 | (1.0%) | 0.199 × 10⁵ |
| | with 0.5% AcOH | | | | |
| 10 g | 10% alkali, water | 1.85 (20.5) | >1920 | (1%) | 1.23 × 10⁵ |
| | wash | | | | |

### EXAMPLE 6

Gracilaria dura collected at different times from Veraval, Gujarat was processed as in Example 3 using 5% alkali. The data are tabulated in Table 5. It can be seen that seasonal variations of seaweed quality are negligible.

TABLE 5
Agars obtained from Gracilaria dura harvested in different times of the year

| Seaweed | | | Yield (g); (% yield | | Gel strength | | | |
|---|---|---|---|---|---|---|---|---|
| Collection | Seaweed | Pretreatment | w.r. to bone dry | | (g/cm²) at | Gelling T | | Sulphate |
| data^{a} | quantity | conditions | seaweed) | | 20° C.; (% gel) | (° C.) | Ash (%) | (%) |
| February | 20 g | 5% alkali, | 4.1 | (22.8) | 1650 (1.0%) | 35.0 | 2.0 | 0.50 |
| 2003 | | water wash | | | | | | |
| April 2003 | 20 g | 5% alkali, | 3.8 | (21.0) | 1620 (1.0%) | 35.0 | 2.02 | 0.50 |
| | | water wash | | | | | | |
| June 2003 | 20 g | 5% alkali, | 4.2 | (23.0) | 1600 (1.0%) | 35.0 | 2.0 | 0.50 |
| | | water wash | | | | | | |
| December | 10 g | 5% alkali, | 1.85 | (20.5) | 1600 (1.0%) | 35.0 | 2.0 | 0.50 |
| 2004 | | water wash | | | | | | |
| January | 15 g | 5% alkali, | 2.90 | (20.0) | 1630 (1.0%) | 35.0 | 2.0 | 0.50 |
| 2004 | | water wash | | | | | | |

### EXAMPLE 7

Gracilaria dura of Example 1 was harvested in January 2004 and transported live to the Gulf of Mannar, Tamil Nadu (9°17′ N and 78°8′ E). Results of cultivation in three different locations (Thonithurai, Ervadi and Krusadai Island) are given in Table 6. The daily growth rate was calculated using the following formula:
r=(Wₜ/W₀)^{1/t}×100,

where r stands for daily growth rate in percent, Wₜ is the wet weight at day t, W₀ is the initial wet weight. It can be seen from Table 6 that cultivation of the seaweed is feasible with daily growth rate as high as 4.34%.

TABLE 6
Cultivation of Gracilaria dura in Perforated
Polythene bags and on Rafts at three different
locations in Gulf of Mannar, Tamil Nadu, India

Method of Cultivation

| | Polythene bags | Raft_Ropes |
|---|---|---|
| Thonithurai | | |
| Initial weight | 250 gm (10 bags × | 1800 gm (18 1.5 m |
| (09.01.′04) | 25 gm each) | ropes × 100 gm each) |
| Final weight | 883 gm | 5076 gm |
| (23.02.′04) | | |
| DGR % day⁻¹ | 2.8 | 2.3 |
| Erwadi | | |
| Initial weight | 100 gm (10 bags × | 900 gm (18 ropes × |
| (13.01.′04) | 10 gm in each bag) | 50 gm in each rope) |
| Final weight | 306 gm | 2318 |
| (27.02.′04) | | |
| DGR % day⁻¹ | 2.5 | 2.1 |
| Krusadai island | | |
| Initial weight | 100 gm (10 bags × | 800 gm (16 ropes × |
| (12.01.′04) | 10 gm in each bag) | 50 gm in each rope) |
| Final weight | 692 gm | 11312 gm |
| (26.02.′04) | | |
| DGR % day⁻¹ | 4.29 | 4.34 |

### EXAMPLE 8

5 kg of fresh Gracilaria dura cultivated in Krusadai island as described in Example 7 was sun-dried to yield a weight of 795 g. 15 g of dry seaweed was processed as described in Example 4, using 10% NaOH for pretreatment, yielding 2.84 g (20% yield) of product having >1920 g/cm² gel strength (1.0% gel; 20° C.), 35° C. gelling temperature, and 0.9% ash content. It can be seen by comparing the present results with the corresponding data in Example 4 that the yield and quality of agarose from cultivated material are the same as those obtained from the naturally occurring seaweed (see Example 4).

### ADVANTAGES OF PRESENT INVENTION

The main advantage of this invention is that agarose of desirable specifications can be produced from Gracilaria dura of Indian waters.

Another advantage is that the yield of agarose is as high as 20-23% based on dry seaweed weight.

Another advantage is that the dry seaweed has adequate shelf life when stored in plastic bags under ambient conditions.

Another advantage is that preparation of the agarose is simple to undertake.

Another advantage is that the seaweed is amenable to cultivation in Indian waters.

1. An agarose of following characteristics:
i. about 1% (≧1900 g/cm²) gel strength at about 20° C.,
ii. 35 to 35.5° C. gelling temperature,
iii. ≦0.25% sulphate content, and
iv. ≦0.9% ash content,
wherein, the agarose is prepared by a simple, direct and cost-effective process from naturally occurring or cultivated Gracilaria spp. more particularly Gracilaria dura, said process comprising steps of:
a. obtaining dry seaweed Gracilaria spp,
b. pre-treating the dry seaweed with about 35 parts (v/w) of about 1 to 15% alkali at 25 to 95° C. for 0.5 to 5.0 hours,
c. rinsing the pre-treated seaweed thoroughly with water to remove excess alkali until the washing shows a pH ranging between 7 and 8,
d. adding about 35 parts (v/w) of water for about every one part of original seaweed and autoclaving at about 115-125° C. for time duration ranging between 1.5 to 2.0 hours to obtain extractive,
e. treating the extractive with about 0.05 to 0.07% charcoal and about 10-15% Celite at a temperature ranging between 85 and 95° C. to obtain hot extractive,
f. vacuum-filtering the hot extractive over a Celite bed,
g. freezing the filtrate into a mass at about −20° C. for 12 to 15 hours and thawing the mass,
h. redissolving the mass in about 25 parts of water by heating in an autoclave,
i. repeating the freeze-thaw cycle if required,
j. straining the product of step (i) to remove thawed liquid and thereafter squeezing to expel residual liquid to the extent possible to obtain agarose, and
k. optionally redissolving the solid and spray drying to obtain fine powder.

2. An agarose as claimed in claim 1, wherein the agarose is obtained from Gracilaria spp. more particularly Gracilaria dura.

3. An agarose as claimed in claim 1, wherein the agarose gel has melting temperature ranging between 98-100° C.

4. A simple, direct and cost-effective process for the preparation of agarose of high gel strength and low gelling temperature from naturally occurring or cultivated Gracilaria spp. more particularly Gracilaria dura, said process comprising steps of:
a. obtaining dry seaweed Gracilaria spp,
b. pre-treating the dry seaweed with about 35 parts (v/w) of about 1 to 15% alkali at 25 to 95° C. for 0.5 to 5.0 hours,
c. rinsing the pre-treated seaweed thoroughly with water to remove excess alkali until the washing shows a pH ranging between 7 and 8,
d. adding about 35 parts (v/w) of water for about every one part of original seaweed and autoclaving at about 115-125° C. for time duration ranging between 1.5 to 2.0 hours to obtain extractive,
e. treating the extractive with about 0.05 to 0.07% charcoal and about 10-15% Celite at a temperature ranging between 85 and 95° C. to obtain hot extractive,
f. vacuum-filtering the hot extractive over a Celite bed,
g. freezing the filtrate into a mass at about −20° C. for 12 to 15 hours and thawing the mass,
h. redissolving the mass in about 25 parts of water by heating in an autoclave,
i. repeating the freeze-thaw cycle if required,
j. straining the product of step (i) to remove thawed liquid and thereafter squeezing to expel residual liquid to the extent possible to obtain agarose, and
k. optionally redissolving the solid and spray drying to obtain fine powder.

5. A process as claimed in claim 4, wherein the alkali is sodium hydroxide.

6. A process as claimed in claim 4, wherein the concentration of alkali is about 10%.

7. A process as claimed in claim 4, wherein the time duration of autoclaving at step (d) is preferentially about 1.5 hours.

8. A process as claimed in claim 4, wherein the agarose yield is ranging between 20-23% of dry seaweed weight.

9. A process as claimed in claim 4, wherein pre-treating the seaweed at temperature preferably about 85° C.

10. A process as claimed in claim 4, wherein pre-treating the seaweed for preferentially about 2.0 hours.

11. A process as claimed in claim 4, wherein the autoclaving is at temperature preferentially about 120° C.

12. A process as claimed in claim 4, wherein concentration of charcoal is about 0.06%.

13. A process as claimed in claim 4, wherein concentration of Celite is about 12.5%.
